(19) United States
(12) Patent Application Publication
(10) Pub. No.: US 2006/0052508 A1
(43) Pub. Date: Mar. 9, 2006

(54) Mixture of sinterable powders for rapid prototyping

(75) Inventor: Franco Cevolini, Baggiovara (IT)

Correspondence Address: MODIANO & ASSOCIATI, Via Meravigli, 16, Milano, 20123, IT

(73) Assignee: C.R.P. TECHNOLOGY S.R.L.

(21) Appl. No.: 11/020,148

(22) Filed: Dec. 27, 2004

(30) Foreign Application Priority Data
Sep. 9, 2004 (IT) MO2004A000227

(51) Int. Cl. C08K 3/40

(52) U.S. Cl. 524/494

(57) ABSTRACT

A mixture of sinterable powders for rapid prototyping, comprising a polymeric matrix in powder form and a reinforcement material in the form of fibers, optionally with the addition of material of a substantially glassy type in the form of microspheres, powdered aluminum and/or powdered graphite.

The present invention relates to a mixture of sinterable powders for rapid prototyping, particularly for SLS (Selective Laser Sintering) processes.

### BACKGROUND OF THE INVENTION

As it is known, rapid prototyping is a technique that has been developed rather recently and allows to obtain automatically the prototype of a mechanical component starting from its corresponding CAD drawing, regardless of its geometry, in a short time and at a relatively low cost.

The resulting prototype can be used as a replacement of the actual component during tests for example of the photoelastic type in order to determine the mechanical characteristics of said component.

It is also known that there are various rapid prototyping technologies, which in any case entail superimposing a plurality of layers of material, which are mutually coupled so as to obtain a model, possibly a scale model, of the actual component.

These technologies differ in the manner in which the layers of material are applied during the construction of the prototype; in particular, each technology is based on a different physical principle, which determines the nature and state of final aggregation of the materials used.

The rapid prototyping process is organized into several steps: initially, the component being studied must be designed with the aid of a three-dimensional solid- or surface-modeling system, so as to obtain a three-dimensional CAD model, which is then converted into a format that can be read by the prototyping machine generally an STL (stereolithography) format.

This conversion consists in approximating the surface of the model by means of a plurality of juxtaposed triangles, which are arranged adjacent to each other so as to cover all of said surface.

The model in the STL format is sectioned by the software that manages the rapid prototyping machine with a plurality of parallel planes that are spaced with an appropriate thickness.

Each plane is one of the layers of material that the machine subsequently superimposes; the contiguous layers are bonded to each other already during the construction of the prototype.

Finally, it is possible to subject the resulting prototype to cleaning and finishing operations or to other kinds of treatment.

One of the known rapid prototyping technologies is constituted for example by the so-called SLS (Selective Laser Sintering) method, which is based on the consolidation of the powders by means of a sintering process obtained by using a laser.

The machine used to perform this method is substantially constituted by a vertically-movable platform on which the powder is deposited, said powder being retained inside the machine at a temperature that is just below its melting point, so as to constitute a layer of uniform thickness, which is struck by the laser only at the region that matches the corresponding cross-section of the model to be provided, causing it to sinter.

The platform then moves downward by an extent that corresponds to the thickness of material that has been deposited, and a new layer of powder is superimposed on the preceding one and sintered as described above, so as to solidify and grip the underlying layer.

The process is repeated until the complete model is obtained.

The material currently used in rapid prototyping processes and particularly in the SLS method is generally constituted by a mixture of powders of the polyamide type, optionally with the addition of powders of various kinds having a reinforcing effect.

Although these mixtures of sinterable powders allow to obtain models of more than satisfactory quality, they are not free from drawbacks, including the fact that the resulting models have limited moduli of elasticity and low ultimate tensile strengths.

### SUMMARY OF THE INVENTION

The aim of the present invention is to provide a mixture of sinterable powders for rapid prototyping that allows to optimize the characteristics of mechanical strength of the models obtained with it.

In view of this aim and of other objects that will become better apparent hereinafter, according to the present invention a mixture of sinterable powders for rapid prototyping is provided which comprises a polymeric powder matrix, characterized in that it comprises reinforcement material in the form of fibers.

The polymeric matrix is preferably of the polyamide type and may comprise for example nylon.

Such reinforcement material may be of the polymeric type, preferably constituted by aramid-type fibers, of the inorganic type, preferably constituted by glass and/or carbon fibers, or of a polymeric and inorganic type.

The expression “aramid fibers” is used to designate fibers made of aromatic polyamides with an aromatic group content of more than 85%.

The aramid-type fibers can be constituted for example by fibers of poly-paraphenyleneterephthalamide known under the brand name Kevlar, and provided by the DuPont Company.

The fibers that constitute the reinforcement material may be of a chopped or milled type.

Conventionally, chopped fibers are fibers with a length between 3 and 6 mm and milled fibers are fibers with a length between 100 and 450 μm.

The mixture may further comprise material of a substantially glassy type in the form of microspheres, powdered aluminum and powdered graphite.

The polymeric matrix, the reinforcement material in the form of fibers, the glassy material in the form of microspheres, the powdered aluminum and the powdered graphite are present in the following quantities, which are mutually independent and are expressed as percentages of the total weight of the mixture:
polymeric matrix, between 20% and 99%; reinforcement material in the form of fibers, between 1% and 80%; glassy material in the form of microspheres, between 0% and 70%; powdered aluminum, between 0% and 70%; powdered graphite, between 0% and 40%.

The polymeric matrix, the reinforcement material in the form of fibers, the glassy material in the form of microspheres, the powdered aluminum and powdered graphite are preferably present in the following quantities, which are mutually independent of each other and are expressed as percentages of the total weight of the mixture:
polymeric matrix, between 50% and 90%; reinforcement material in the form of fibers, between 10% and 50%; glassy material in the form of microspheres, between 15% and 25%; powdered aluminum, between 10% and 25%; powdered graphite, between 0% and 10%.

According to conventional operating methods and depending on the quantities to be produced, the mixture according to the invention can be prepared by mechanical mixing (for example, inside mixers in which the appropriate quantities of the various components are introduced) or by pneumatic mixing (for example, by blowing air into silos that contain the various components); alternative embodiments are of course not excluded.

The resulting mixture is ready for use and can therefore feed conventional rapid prototyping machines, particularly machines for performing the SLS method.

Conveniently, said mixture can be applied in all conventional fields of use of rapid prototyping, such as for example the manufacture of parts of vehicles, electrical household appliances, design items or others.

Advantageously, it has been found by means of laboratory tests that the models provided with the mixture according to the invention have a greater mechanical strength than prototypes obtained with conventional materials, both at ambient temperature and at high temperatures.

Moreover, significant increases in elastic modulus and in the ultimate tensile strength of the material have been observed.

The ultimate tensile strength of the material obtained by sintering the mixture according to the present invention is in fact on the order of magnitude of 55-60 MPa, whereas the ultimate tensile strength of the materials conventionally used in rapid prototyping is on the order of magnitude of 40-48 MPa.

The following examples are given only as an illustration of the present invention and must not be understood as limiting its scope as defined by the accompanying claims.

### EXAMPLE 1

A first mixture of sinterable powders for rapid prototyping that can be obtained from the following components:

| | |
|---|---|
| polymeric matrix | 60% |
| reinforcement material in the form of fibers | 30% |
| glassy material in the form of microspheres | 10% |
| powdered aluminum | 0% |
| powdered graphite | 0% |

### EXAMPLE 2

A second mixture of sinterable powders for rapid prototyping that can be obtained from the following components:

| | |
|---|---|
| polymeric matrix | 50% |
| reinforcement material in the form of fibers | 20% |
| glassy material in the form of microspheres | 15% |
| powdered aluminum | 10% |
| powdered graphite | 5% |

The persons skilled in the art would readily understand that other mixtures of sinterable powders may be prepared, based on the disclosure of the invention set forth above, all of which however would be considered as comprised within the scope of the claims.

The disclosures in Italian Patent Application No. MO2004A000227 from which this application claims priority are incorporated herein by reference.

What is claimed is:

1. A mixture of sinterable powders for rapid prototyping, comprising a polymeric matrix in powder form, comprising a reinforcement material in the form of fibers.

2. The mixture of claim 1, wherein said reinforcement material is of a substantially polymeric and/or inorganic type.

3. The mixture of claim 2, wherein said polymeric reinforcement material is of an aramid type.

4. The mixture of claim 2, wherein said inorganic reinforcement material comprises at least glass or carbon or both glass and carbon.

5. The mixture of claim 3, wherein said aramid polymeric reinforcement material comprises at least Kevlar.

6. The mixture of claim 1, wherein said fibers are provided of a chopped and/or milled type.

7. The mixture of claim 1, wherein said polymeric matrix is of a substantially polyamide type.

8. The mixture of claim 7, wherein said polyamide polymeric matrix comprises nylon.

9. The mixture of claim 2, comprising a material of a substantially glassy type, provided in a form of microspheres.

10. The mixture of claim 9, comprising powdered aluminum.

11. The mixture of claim 10, comprising powdered graphite.

12. The mixture of claim 1, wherein said polymeric matrix is provided in quantities comprised between 20% and 99% by weight.

13. The mixture of claim 12, wherein said polymeric matrix is provided in quantities comprised between 50% and 90% by weight.

14. The mixture of claim 2, wherein said reinforcement material is provided in quantities comprised between 1% and 80% by weight.

15. The mixture of claim 14, wherein said reinforcement material is preferably provided in quantities comprised between 10% and 50% by weight.

16. The mixture of claim 9, wherein said glassy material in the form of microspheres is provided in quantities comprised between 0% and 70% by weight.

17. The mixture of claim 16, wherein said glassy material in the form of microspheres is preferably provided in quantities comprised between 15% and 25% by weight.

18. The mixture of claim 10, wherein said powdered aluminum is provided in quantities comprised between 0% and 70% by weight.

19. The mixture of claim 18, wherein said powdered aluminum is preferably provided in quantities comprised between 10% and 25% by weight.

20. The mixture of claim 11, wherein said powdered graphite is present in quantities comprised between 0% and 40% by weight.

21. The mixture of claim 20, wherein said powdered graphite is preferably provided in quantities comprised between 0% and 10% by weight.

22. The mixture of claim 10, wherein said polymeric matrix, said reinforcement material in the form of fibers, said glassy material in the form of microspheres, said powdered aluminum and said powdered graphite are provided in the following quantities, by weight:

| | |
|---|---|
| polymeric matrix | 60% |
| reinforcement material in the form of fibers | 30% |
| glassy material in the form of microspheres | 10% |
| powdered aluminum | 0% |
| powdered graphite | 0% |

23. The mixture of claim 10, wherein said polymeric matrix, said reinforcement material in the form of fibers, said glassy material in the form of microspheres, said powdered aluminum and said powdered graphite are provided in the following quantities, by weight:

| | |
|---|---|
| polymeric matrix | 50% |
| reinforcement material in the form of fibers | 20% |
| glassy material in the form of microspheres | 15% |
| powdered aluminum | 10% |
| powdered graphite | 5% |
